(19) United States
(12) Patent Application Publication
(10) Pub. No.: US 2009/0234872 A1
(43) Pub. Date: Sep. 17, 2009

(54) SYNCHRONIZATION OF DISCONNECTED/OFFLINE DATA PROCESSING/ENTRY

(75) Inventor: Neil Leonard Padgett, Redmond, WA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 12/045,872

(22) Filed: Mar. 11, 2008

(51) Int. Cl. G06F 17/30

(52) U.S. Cl. 707/102; 707/E17.009

(57) ABSTRACT

Systems and methods are provided for the synchronization of off-line data with one or more cooperating computing environments. Illustratively, an exemplary synchronization environment comprises a synchronization engine, a data store, and an instruction set comprising at least one instruction to instruct the exemplary synchronization engine to coordinate the synchronization of data received by the exemplary synchronization engine from one or more cooperating data source endpoints. Illustratively, a request for synchronization and data to be synchronized can be received by the exemplary synchronization engine from one or more cooperating endpoints source endpoints. Responsive to the request for synchronization, the exemplary synchronization engine can apply a selected synchronization paradigm (e.g., knowledge based synchronization) to the received data to allow for the synchronization of data. that is, for example, stored on a cooperating data store.

### BACKGROUND

In many practical enterprise applications of computer systems, technological or security considerations necessitate that the systems need not be electronically connected (e.g., connected in an online manner). For example, several batch systems may communicate to merge changes made on the different systems only at various intervals (weekly, daily, etc.). As another example is military computer system; in such environments, systems with different security levels are generally not electronically connected. In extreme cases, current practices can require an operator to print out and manually input data obtained from a cooperating secure system. Also in various government applications, there are forms processing tasks where the form entry may be online (e.g., by the customer via a web browser computing application), but the processing uses physical forms. In all of these examples, the problem of data being manipulated on various endpoints at once, some electronic, some perhaps not.

There are a variety of distributed data systems that have devices and objects that share data with one another. For instance, music sharing systems may synchronize music between a PC, a Cell phone, a gaming console and an MP3 player. Email data may be synchronized among a work server, a client PC, and a portable email device. Today, to the extent such devices synchronize according to common information, the synchronization takes place according to a static setup among the devices. However, when these devices are loosely coupled such that they may become disconnected from communications with each other, e.g., when a Cell phone is in a tunnel, or when the number of devices to be synchronized is dynamic, it is desirable to have a way for the devices to determine what changes each other device needs when they re-connect to one another, or as they join the network. Additionally, electronic systems might require update from non-electronic offline data sources (e.g., printed forms, security enabled applications requiring print outs of data, etc.).

A number of solutions are in use to address the persistent editing endpoint issue across distributed systems. Typically, in many online applications, endpoint editing can be mitigated by allowing the data to change on one endpoint. For example, for batch processing systems, changes might be disallowed on the computer systems other than made on a selected system (e.g., “owner” system). For other security enabled systems and applications (e.g., military and government applications), a human operator can be employed to manually merge changes made on different endpoints simultaneously. For forms processing, the task of synchronizing off-line non-electronic data can be especially difficult, since more than one office worker can print a copy of the form for processing at once; e.g., different workers may process different sections of the same form. Such practice can lead to multiple conflicting updates; e.g., the different workers may choose to both update some common section of the form.

Current solutions, however are arduous at best for participating users requiring substantial expenditure of resources including time, labor, and money. Current solutions also do not leverage synchronization technologies that could be applied to existing practices to increase reliability, promote efficiency, and reduce the need for the various resources. Additionally, current solutions do not provide a communications/data processing interface to allow for the cooperation of off-line non-electronic data with electronic systems and applications.

From the foregoing is appreciated that there exists a need for systems and methods to overcome the shortcomings of existing practices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The herein described systems and methods provide for the synchronization of off-line data with one or more cooperating computing environments. In an illustrative implementation, an exemplary synchronization environment comprises a synchronization engine, a data store, and an instruction set comprising at least one instruction to instruct the exemplary synchronization engine to coordinate the synchronization of data received by the exemplary synchronization engine from one or more cooperating data source endpoints.

In an illustrative operation, a request for synchronization and data to be synchronized can be received by the exemplary synchronization engine from one or more cooperating endpoints source endpoints. Responsive to the request for synchronization, the exemplary synchronization engine can apply a selected synchronization paradigm (e.g., knowledge based synchronization) to the received data to allow for the synchronization of data that is for example stored on a cooperating data store and the received data and/or between the received data received from the one or more cooperating

In the illustrative implementation, the synchronization paradigm can comprise one or more instructions provided to the exemplary synchronization engine to perform one or more operations comprising application of knowledge to offline data, application of non-knowledge based synchronization to received data and/or stored data, encoding/affixing version data (e.g., human readable and/or machine readable version data) to an instrumentality of the received data (e.g., a paper form), encoding/affixing knowledge data (e.g., human readable and/or machine readable version data) to an instrumentality of the received data (e.g., a paper form), storing synchronization metadata for the received data and/or storing identification data to an instrumentality of the received data illustratively operative to reference synchronization metadata during one or more synchronization processes, and filtering of received data as part of the synchronization processing.

The following description and the annexed drawings set forth in detail certain illustrative aspects of the subject matter. These aspects are indicative, however, of but a few of the various ways in which the subject matter can be employed and the claimed subject matter is intended to include all such aspects and their equivalents.

### BRIEF DESCRIPTION OF THE DRAWINGS

The system and methods for representing synchronization knowledge for offline data sources sharing common information operative to accommodate the synchronization of offline non-electronic data are further described with reference to the accompanying drawings in which:

FIG. 1 illustrates a dedicated synchronization system that provides synchronization between two well defined endpoints of the system;

FIG. 2A illustrates exemplary non-limiting knowledge exchange between two data sources of a loosely connected network of nodes in accordance with the herein described systems and methods;

FIG. 2B is a block diagram of an exemplary non-limiting implementation of an exemplary for performing a knowledge exchange in accordance with the herein described systems and methods;

FIG. 3 illustrates exemplary non-limiting knowledge exchange between cooperating data sources of a loosely connected network of nodes in accordance with the herein described systems and methods;

FIG. 4 illustrates exemplary non-limiting knowledge exchange between cooperating components of a loosely connected network of nodes in accordance with the herein described systems and methods;

FIG. 4A illustrates other exemplary non-limiting knowledge exchange between cooperating components of a loosely connected network of nodes in accordance with the herein described systems and methods;

FIGS. 5A, 5B and 5C illustrate exemplary knowledge exchange in the context of multiple objects shared among nodes of a network in accordance with the herein described systems and methods;

FIG. 6 is an exemplary non-limiting flow diagram illustrating the process for knowledge exchange in the context of multiple data sources cooperating in a network in accordance with the herein described systems and methods;

FIG. 7 is a block diagram representing an exemplary non-limiting networked environment in which the present invention may be implemented; and

FIG. 8 is a block diagram representing an exemplary non-limiting computing system or operating environment in which the present invention may be implemented.

### DETAILED DESCRIPTION

### Overview

As discussed in the background, there is no way to efficiently represent synchronization knowledge for a set of loosely coupled online and offline data sources that do not remain in dedicated contact with one another. Where dedicated contact can be presumed, any changes can immediately or periodically be pushed out to the data sources that should receive them. Where dedicated contact cannot be presumed, however, with data sources appearing and disappearing, efficiently representing what those data sources know and do not know from a synchronization standpoint is desirable.

Accordingly, the herein described systems and methods enables efficient knowledge representation for distributed data sources (online and offline) in data synchronization systems. An efficient mechanism is provided to ensure whenever a data source updates its data in a loosely coupled network of cooperating data sources, the updated data source can illustratively operatively allow for the exchange of knowledge with one or more other data sources in order to determine which changes should be noted and possible stored for subsequent processing.

In this fashion, while a first data source and a third data source may never communicate directly, if each is able to connect to a synchronization engine, a collective share of knowledge can be achieved across all of the data sources cooperating with the synchronization engine, determining what changes/updates each of the data sources should perform. Considering the proliferation of shared data sources; such as paper forms, non-electronic artwork, physical pictures the knowledge exchange techniques of the herein described systems and methods can be scalable to any number of data sources, and any number of independent knowledge bases (i.e., different sets of common information) simultaneously, i.e., anywhere any evolving set of data sources wish to share data updates. Various embodiments of representing such knowledge in a distributed system are described in more detail below.

### Efficient Knowledge Representation and Exchange

In various exemplary, non-limiting embodiments described below, knowledge is efficiently represented in data synchronization systems. Non-limiting benefits that can be achieved with the herein described systems and methods include an efficient identification of knowledge for one or more data sources that can process minimum data needed to efficiently and correctly recognize data updates for a given data source, i.e., the ability to synchronize an arbitrary number of offline data sources and the ability to synchronize any data source via any other data source, i.e., the ability to work in a peer to peer, multi-master synchronization environment.

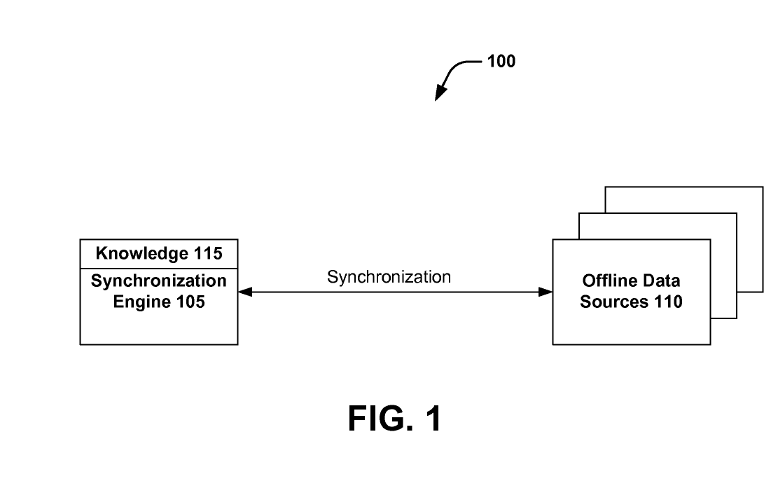

FIG. 1 illustrates, a high level synchronization environment 100 for the synchronization of offline data, where an exemplary synchronization engine 105 cooperates with one or more data sources 110 to synchronize data updates provided by the one or more data sources 110 (e.g., among, between, or within data sources 110). Due to the dedicated synchronization between the synchronization engine 105, the state of the necessary knowledge 115 to synchronize between the cooperating offline data sources 110 can be tracked by the synchronization engine 105. Such knowledge 115 can also optionally be tracked by one or cooperating offline data source 110 well, however, when the connection between synchronization engine 105 and offline data sources 110 becomes disconnected at times, and when the number of synchronizing data sources increases, tracking the necessary knowledge across all of those devices becomes a difficult problem.

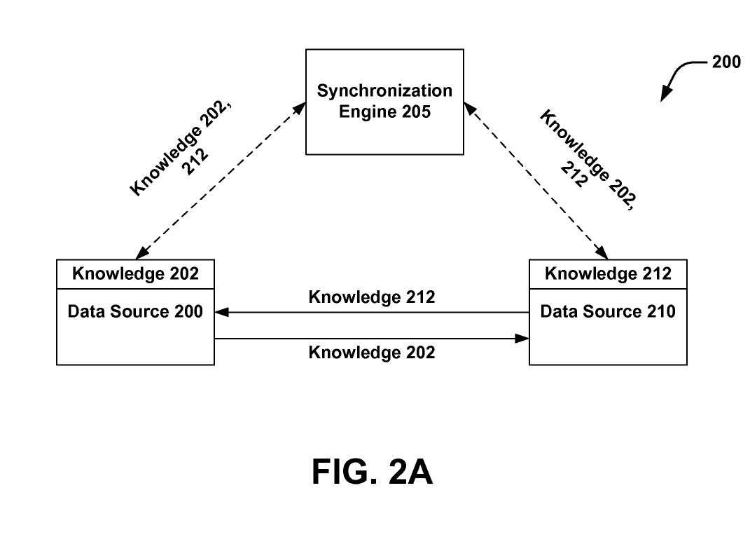

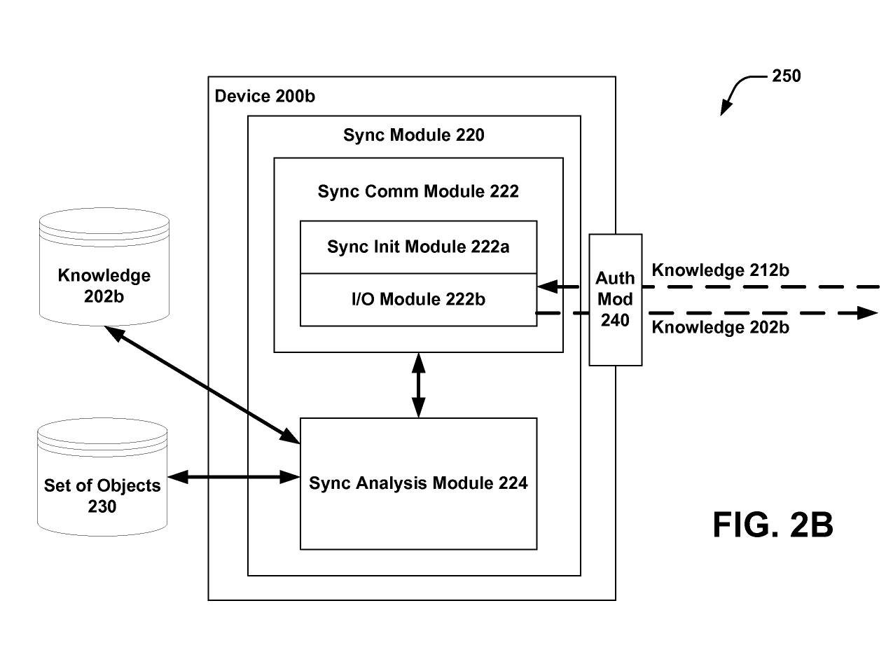

FIG. 2A illustrates, at a high level, the knowledge exchange of the invention between two cooperating data stores 200 and 210 (e.g., devices). In accordance with the herein described systems and methods, any number of changes might be made to some information that is to be shared between the data sources 200 and 210. At any time they cooperate (i.e., with an exemplary synchronization engine), however, by exchanging their knowledge 202 and 212, they become aware of at least the minimum amount of information needed to reconstruct what each other knows and doesn't know to facilitate of changes between the data sources (i.e., as facilitated by an exemplary synchronization engine). It is noted that where more than two data sources are involved, knowledge 202 and 212 may be incomplete knowledge of a greater base of information to be shared, but as more knowledge is shared around the multiple data sources, collective knowledge continues to be accrued by the data sources as they connect to the other data source over time.

FIG. 2B is a block diagram of an exemplary non-limiting implementation of a device 200b for performing a knowledge exchange in accordance with the invention. As shown, device 200b includes a sync module 220 that performs the knowledge exchange techniques for synchronizing a set of objects 230 with another device in accordance with the invention. Sync module 220 may include a sync communications module for generally transmitting and receiving data in accordance with the knowledge exchange techniques of the invention.

Sync module 220 may include a sync initiation module 222a which may initiate synchronization with a second device if authorized, e.g., via authorization module 240, and connected to the second device. Sync module may also include an I/O module responsive to the initiation of synchronization by sending knowledge 202b about the set of objects 230 to the second device (not shown) and for receiving back knowledge 212b of the second device and changes to be made to the set of objects 230 originating from the second device. In turn, a sync analysis module 224 operates to apply the changes to be made to the set of objects 230 and to compare knowledge 212b from the second device with the knowledge 202b of the first device in order to determine changes to send to the second device to complete synchronization between the devices.

Advantageously, the herein described systems and methods operate to perform synchronization for a set of devices all interested in maintaining the latest versions of a set of objects, but also allows such devices to come into connection and out of connection with the other objects of the set. Whenever a device comes back into connection with other device(s) of the set of devices via one or more networks, the device regains collective knowledge that is as up to date as the other device(s) represent with their collective knowledge. In this fashion, even loosely connected devices may come into and out of contact with a set of devices, and then relearn all the knowledge it has missed by coming into contact with any set of devices that possesses the latest set of collective knowledge.

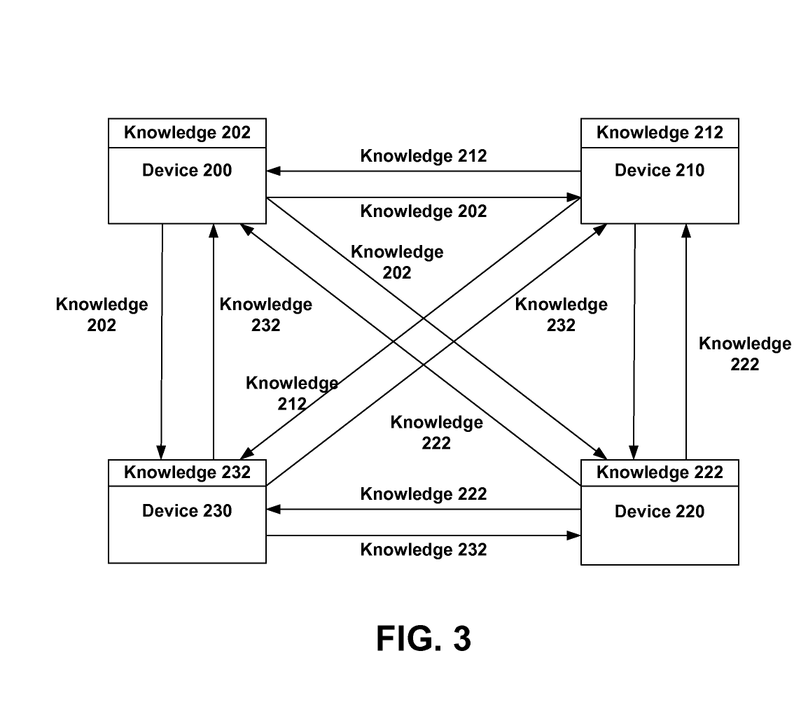

FIG. 3 illustrates that the knowledge exchange of the herein described systems and methods is generalizable, or scalable, to any number of devices. As shown, four devices 200, 210, 220 and 230 are shown with knowledge representations 202, 212, 222 and 232 that respectively indicate what each device knows and doesn't know about a set of common information to be shared across the devices.

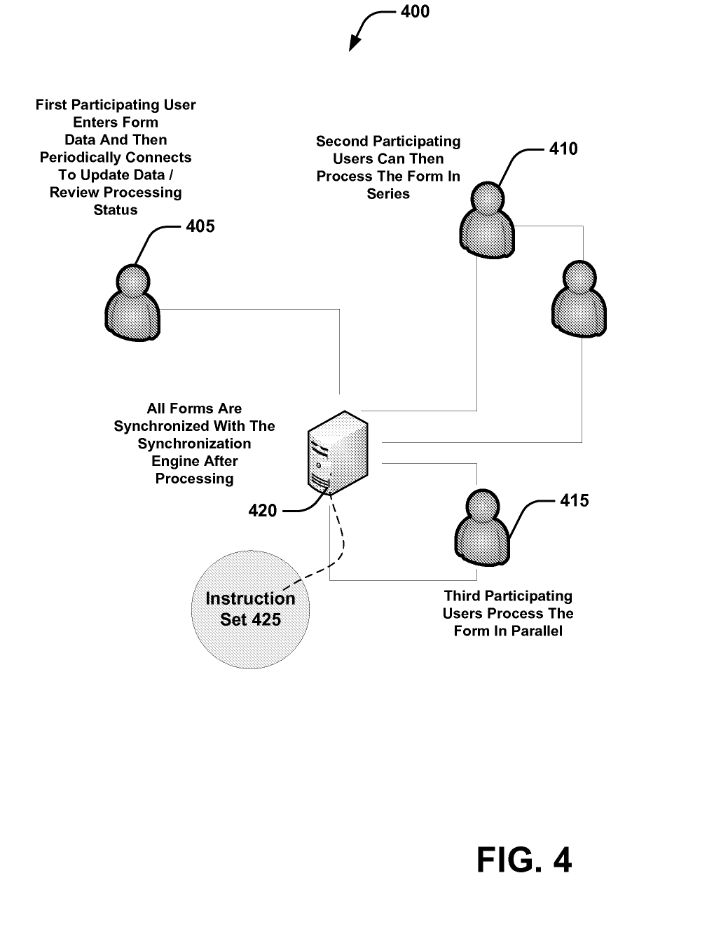

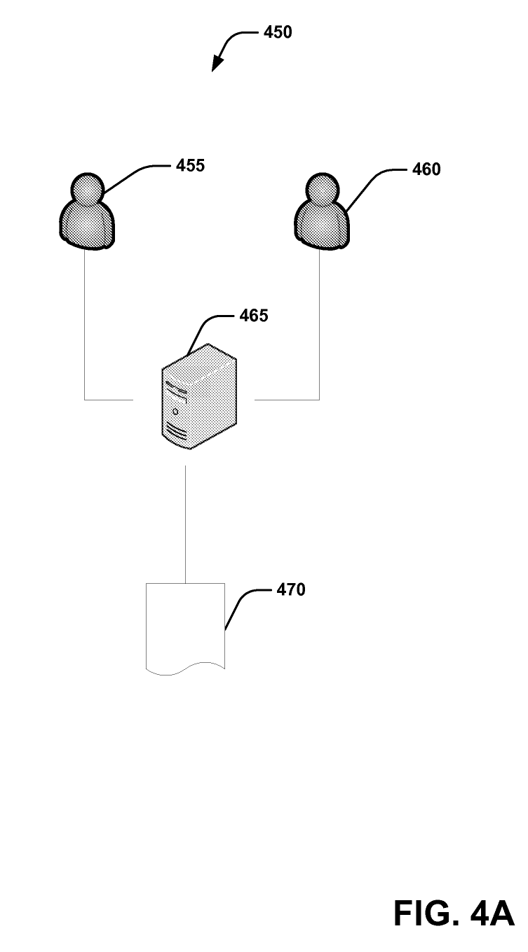

FIG. 4 illustrates the interaction of various cooperating parties and components of exemplary synchronization environment 400. As is shown in FIG. 4, in an illustrative implementation, exemplary synchronization environment 400 comprises a first participating user 405, one or more second participating users 410, third participating users 415, synchronization engine 420, and instruction set 425. In an We consider the case of forms processing. In an illustrative operation, first participating 405 can enter form data (e.g., data on a form) while second participating users 420 can enter data for the same form in series to first participating user 405. In the illustrative operation, third participating users 415 can enter data on the form in parallel to the second participating users 410. The forms from the participating users can then be processed by synchronization server 420 executing one or more instructions from instruction set 425.

The illustrative implementation of FIG. 4 can be representative of an exemplary use case for the synchronization of off-line data. In this exemplary use case, a bureaucracy that processes forms is considered. In this example, customers do some initial data entry online (though it could be on a paper form). Then the workers print various copies of the form and work on it offline, perhaps routing the form between several workers before the form returns to the server. Additionally, multiple copies of the form may be routed amongst different workers (for potential update) at the same time; that is, at any time there may be more than one paper form “outstanding”.

In this exemplary user case, a sync topology can exist between the various paper forms and the computer system (e.g., synchronization server 420). The computer system can be an endpoint as is each paper form. Each can be considered a replica with its own identification data (though generations of the same form given to the same worker may have the same replica identification data).

Illustratively, sync metadata can be affixed to each form. In particular, in the case of knowledge sync, knowledge (including the replica key map if employed) can be affixed to the form and the sync versions associated with each data item (i.e., field) on the form. The metadata can be affixed in some machine readable form (e.g., barcode, magnetic stripe, RFID) or in some human readable form (numbers, letters, etc.) Alternately, some human or machine readable identifier or reference can be stored for the form that serves as an index to some well-known metadata server that can be accessed to retrieve metadata for the form during later synchronization operations.

In the illustrative implementation the data element can be identified on the form such that its item/change unit id for synchronization can bet determined later. Such operation can be performed by encoding the data on the form or it can be inferred from context. For example, each field may have a well-known position on the form.

The forms can illustratively be synchronized with a computer server (e.g., synchronization engine 420) that can be a participant in the sync topology. Operatively, this can be accomplished by performing change detection on the form (e.g., either asking one of the participating users to key the changes or determining them via some machine reading methods—e.g., optical character recognition (OCR) and communicate the changed to data to the computer. Standard synchronization techniques can then be performed.

In the illustrative operation for the exemplary use case, knowledge synch can illustratively perform the following method: 1) load the form data and detect changes, storing the changes in temporary storage; 2) get sync metadata for the form (knowledge, versions) from either the form or the metadata server and store it in temporary storage on the computer; 3) perform a sync between the endpoint on the computer server and the temporary storage; and 4) record the updated tick-count on the form or destroy the form and issue a new copy of the form with the updated tick-count affixed.

FIG. 4A is a block diagram of exemplary synchronization environment 450. As is shown in FIG. 4A, exemplary synchronization environment 450 comprises first participating user 455, second participating user 460, synchronization engine 465, and output data 470. In an illustrative operation, first participating user 455 can populate form data for a first form (not shown) and second participating user 460 can populate form data for a second form (not shown). The content of the first form and second form (not shown) can be merged by synchronization engine 465 to produce output data 470.

In an exemplary use case representative of a deployment of the illustrative implementation, two machine readable forms through the use of some intermediate computer system (e.g., synchronization engine 420 of FIG. 4) can be merged. In the illustrative implementation, the synchronization of the forms can be operable such that the forms do need not have any access to a cooperating data store, nor need it be an endpoint. Instead, the computer server (e.g., synchronization engine 420 of FIG. 4) can perform a “bidirectional sync” between the two forms as follows according to an exemplary method comprising illustrative steps of: 1) reading data and sync metadata (e.g., versions, knowledge) from a first form (e.g., via OCR) and storing it in the computer in some temporary storage (e.g. a cooperating data store); 2) reading data and sync metadata from a second form and storing the data and metadata in a cooperating data store; 3) performing a sync between the two temporary stores detecting and resolving conflicts as appropriate, either automatically or via feedback from the console operator; 4) issue a new form corresponding to either of the two temporary stores (including knowledge with the replica identification of the newly chosen store and appropriately updated versions). Alternately, the synchronization engine can issue two forms, one per temporary store, if both workers need a copy of the form; and 5) discard the data/metadata from temporary storage.

Illustratively, the exemplary method can be extended to more than two forms by loading the input forms into temporary storage and performing an exemplary bidirectional sync operation between the temporary stores until steady-state is reached.

Illustratively, if a form will not be merged with another form and a form will be synchronized with the same central computer, then a form may be considered a simple participant. In this illustrative implementation, it is not necessary to stores versions/knowledge on the form. Instead the form need can operate to store a selected identifier such the form can be identified by the central participant.

We can also consider the scenario of different forms, each with a subset of the data. For example, perhaps the second participating user 410 as described in FIG. 4 do not need the same subset of the data as the third participating user 415 as described in FIG. 4. In such a case, each form can be considered to maintain a filtered representation of the overall data set; i.e., the forms are filtered replicas. Illustratively, the filter definition can be inferred from the particular form style, or could be stored explicitly, either with the form or on the well-known metadata server.

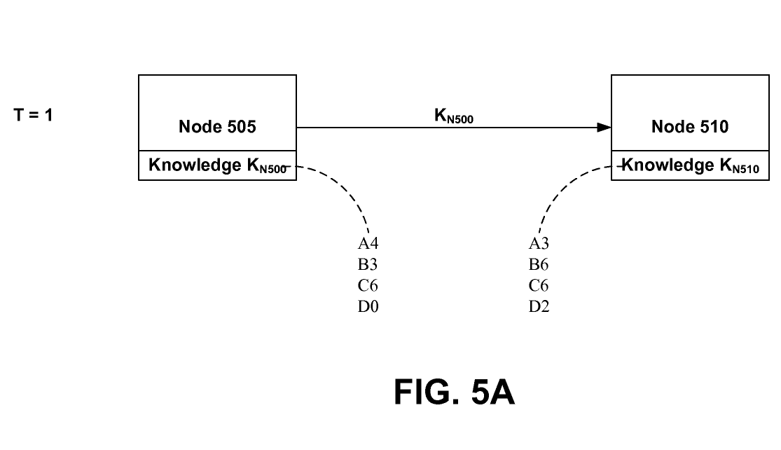

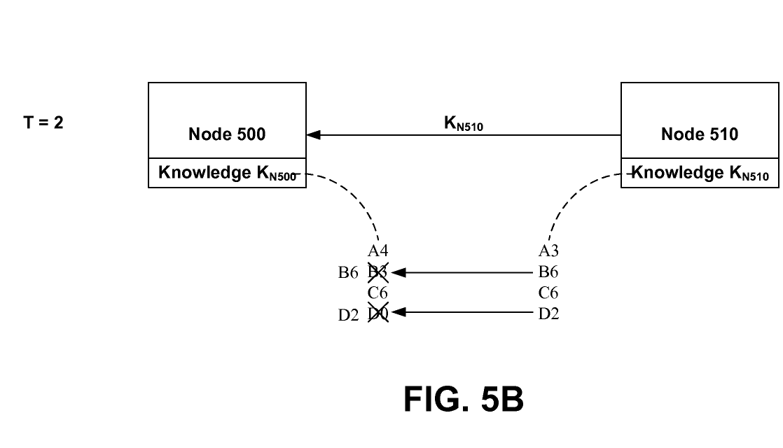

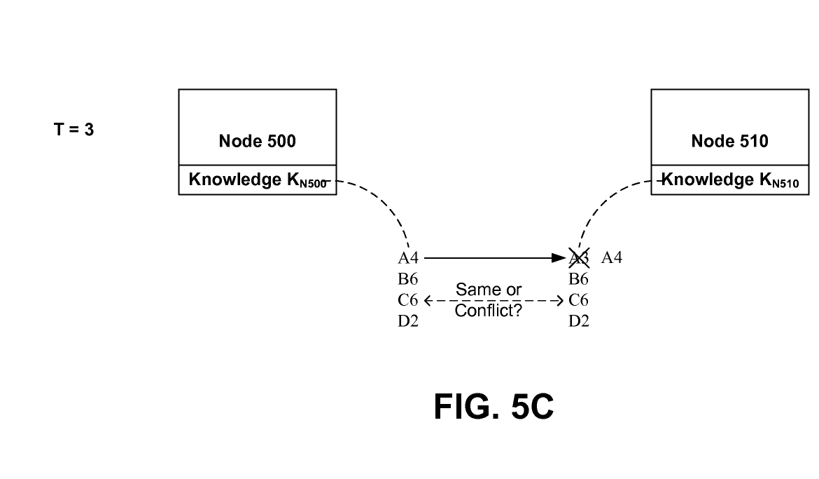

FIG. 5 shows an exemplary synchronization environment 500, node 505 of a peer-to-peer network having any number of nodes wants to exchange data with Node 510. Node A begins by requesting changes from Node 510 and in order to do so Node 505 sends its knowledge (represented as KN₅₀₅) to Node 510 as shown.

In the example shown, exemplary knowledge of a device or node is represented by labeling each object to be shared among devices with a letter identifier, and then the trailing number represents the latest version for this object. For instance, K_{N500} as shown in FIG. 5A includes objects A, B, C and D each to be synchronized between nodes 500 and 510, and the number following each of the objects represents the latest version of the object known on the device. For instance, knowledge K_{N500} at a time t=1 includes the 5^{th} version of A, the 4^{th} version of B, the 7^{th} version of C, and the 1^{st} version of D, notated as A4, B3, C6, D0 in FIG. 5. In contrast, knowledge KN₅₁₀ of node 510 at a time t=1 may include the 4^{th} version of A, the 7^{th} version of B, the 7^{th} version of C, and the 3^{rd} version of D, notated as A3, B6, C6, D2 in FIG. 5.

As shown in FIG. 5B, at time T=2, node 510 compares knowledge K_{N500} received from node 500 against its own knowledge K_{N510} and determines what needs to be sent to node 500. In this example, as a result, node 510 will send node 500 the changes relating to B and D since node 500's knowledge of B3, D0 is behind node 510's knowledge of B6 and D2. When node 510 sends node 500 the changes between B6 and B3, and the changes between D2 and D0, it also sends along the latest version of knowledge K_{N510} it has (reflecting whenever the last change on node 510 was made).

As shown in FIG. 5C, representing time t=3, sending knowledge K_{N510} to node 500 allows node 500 to detect conflicts (e.g., store them for later resolution) if it later finds out that both node 500 and node 510 made a change to an object while they were on the same version. This allows for autonomous updating, efficient enumeration, but also correct conflict detection when the nodes meet and exchange changes. For instance, in the example, if C6 is not the same object in both knowledge K_{N510} and K_{N510}, e.g., if both independently evolved from C5 to C6, then which C6 is the correct C6 can be set aside for conflict resolution, e.g., according to pre-set policy resolution that befits the synchronization scenario and devices involved.

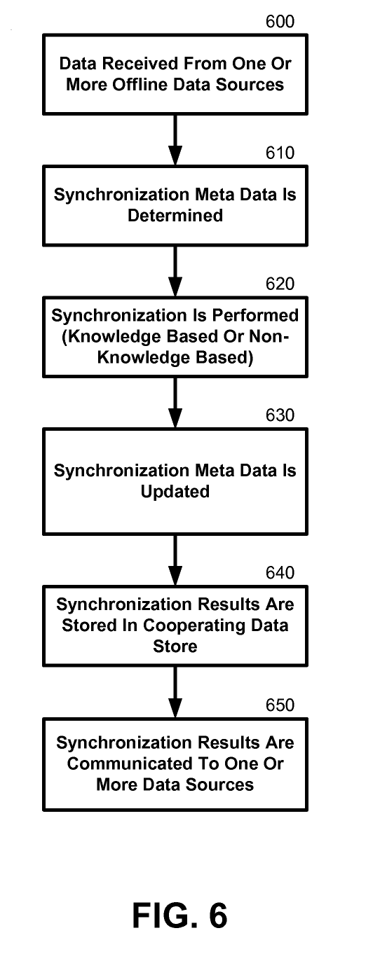

An exemplary knowledge exchange process for data sources of a distributed multi-master synchronization environment occurs is shown in the flow diagram of FIG. 6. At 600, data is received from one or more data sources. Processing then proceeds to block 600 where synchronization meta data can be determined. Synchronization can then be performed at block 620 (e.g., knowledge based synchronization or non-knowledge based synchronization depending on the nature of the data received from the one or more offline data sources). Synchronization meta data can then be updated at block 630. Synchronization results can then be stored in one or more cooperating data stores at block 640. Processing then proceeds to block 650 where synchronization results can be communicated to one or more data sources (e.g., generate new data sources representative of synchronized/updated data to replace one or more data sources providing data such as in described in block 600).

The systems and methods for efficiently representing knowledge of the herein described systems and methods may also be applied to the context of resolving in memory data on the same provider. In such context, the in memory data may not be backed by a physical store, e.g., it might be used in a graph solver on the CPU to synchronize nodes. The herein described systems and methods may also be applied in the context of scene graphs, especially as they become more distributed on multi-core architectures and calculations are written directly to an in memory data structure such as a volumetric texture.

### Exemplary Networked and Distributed Environments

One of ordinary skill in the art can appreciate that the synchronization knowledge representation and exchange of the invention can be implemented in connection with any computer or other client or server device, which can be deployed as part of a computer network, or in a distributed computing environment, connected to any kind of data store. In this regard, the present invention pertains to any computer system or environment having any number of memory or storage units, and any number of applications and processes occurring across any number of storage units or volumes, which may be used in connection with synchronization techniques in accordance with the present invention. The present invention may apply to an environment with server computers and client computers deployed in a network environment or a distributed computing environment, having remote or local storage. The present invention may also be applied to standalone computing devices, having programming language functionality, interpretation and execution capabilities for generating, receiving and transmitting information in connection with remote or local services and processes.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices may have applications, objects or resources that may implicate the systems and methods for synchronizing in accordance with the invention.

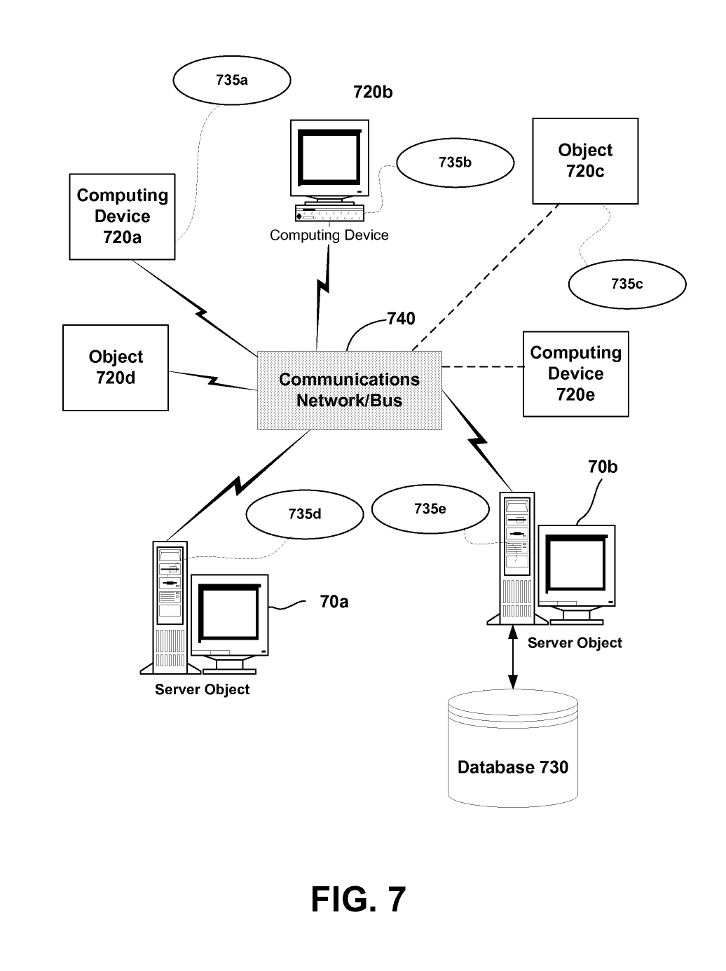

FIG. 7 provides a schematic diagram of an exemplary networked or distributed computing environment. The distributed computing environment comprises computing objects 710a, 710b, etc. and computing objects or devices 720a, 720b, 720c, 720d, 720e, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 740. This network may itself comprise other computing objects and computing devices that provide services to the system of FIG. 7, and may itself represent multiple interconnected networks. In accordance with an aspect of the invention, each object 710a, 710b, etc. or 720a, 720b, 720c, 720d, 720e, etc. may contain an application that might make use of an API, or other object, software, firmware and/or hardware, suitable for use with the systems and methods for synchronizing with knowledge in accordance with the invention.

It can also be appreciated that an object, such as 720c, may be hosted on another computing device 710a, 710b, etc. or 720a, 720b, 720c, 720d, 720e, etc. Thus, although the physical environment depicted may show the connected devices as computers, such illustration is merely exemplary and the physical environment may alternatively be depicted or described comprising various digital devices such as PDAs, televisions, MP3 players, etc., any of which may employ a variety of wired and wireless services, software objects such as interfaces, COM objects, and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for exemplary communications made incident to synchronizing according to the present invention.

In home networking environments, there are at least four disparate network transport media that may each support a unique protocol, such as Power line, data (both wireless and wired), voice (e.g., telephone) and entertainment media. Most home control devices such as light switches and appliances may use power lines for connectivity. Data Services may enter the home as broadband (e.g., either DSL or Cable modem) and are accessible within the home using either wireless (e.g., HomeRF or 802.11B) or wired (e.g., Home PNA, Cat 5, Ethernet, even power line) connectivity. Voice traffic may enter the home either as wired (e.g., Cat 3) or wireless (e.g., cell phones) and may be distributed within the home using Cat 3 wiring. Entertainment media, or other graphical data, may enter the home either through satellite or cable and is typically distributed in the home using coaxial cable. IEEE 1394 and DVI are also digital interconnects for clusters of media devices. All of these network environments and others that may emerge, or already have emerged, as protocol standards may be interconnected to form a network, such as an intranet, that may be connected to the outside world by way of a wide area network, such as the Internet. In short, a variety of disparate sources exist for the storage and transmission of data, and consequently, any of the computing devices of the present invention may share and communicate data in any existing manner, and no one way described in the embodiments herein is intended to be limiting.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 7, as an example, computers 720a, 720b, 720c, 720d, 720e, etc. can be thought of as clients and computers 710a, 710b, etc. can be thought of as servers where servers 710a, 710b, etc. maintain the data that is then replicated to client computers 720a, 720b, 720c, 720d, 720e, etc., although any computer can be considered a client, a server, or both, depending on the circumstances. Any of these computing devices may be processing data or requesting services or tasks that may implicate the synchronization techniques with knowledge in accordance with the invention.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques for synchronizing based on knowledge in accordance with the invention may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 7 illustrates an exemplary networked or distributed environment, with server(s) in communication with client computer(s) via a network/bus, in which the present invention may be employed. In more detail, a number of servers 710a, 710b, etc. are interconnected via a communications network/bus 740, which may be a LAN, WAN, intranet, GSM network, the Internet, etc., with a number of client or remote computing devices 720a, 720b, 720c, 720d, 720e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to synchronize any kind of data.

In a network environment in which the communications network/bus 740 is the Internet, for example, the servers 710a, 710b, etc. can be Web servers with which the clients 720a, 720b, 720c, 720d, 720e, etc. communicate via any of a number of known protocols such as HTTP. Servers 710a, 710b, etc. may also serve as clients 720a, 720b, 720c, 720d, 720e, etc., as may be characteristic of a distributed computing environment.

As mentioned, communications may be wired or wireless, or a combination, where appropriate. Client devices 720a, 720b, 720c, 720d, 720e, etc. may or may not communicate via communications network/bus 14, and may have independent communications associated therewith. For example, in the case of a TV or VCR, there may or may not be a networked aspect to the control thereof. Each client computer 720a, 720b, 720c, 720d, 720e, etc. and server computer 710a, 710b, etc. may be equipped with various application program modules or objects 135a, 135b, 135c, etc. and with connections or access to various types of storage elements or objects, across which files or data streams may be stored or to which portion(s) of files or data streams may be downloaded, transmitted or migrated. Any one or more of computers 710a, 710b, 720a, 720b, 720c, 720d, 720e, etc. may be responsible for the maintenance and updating of a database 730 or other storage element, such as a database or memory 730 for storing data processed or saved according to the invention. Thus, the present invention can be utilized in a computer network environment having client computers 720a, 720b, 720c, 720d, 720e, etc. that can access and interact with a computer network/bus 740 and server computers 710a, 710b, etc. that may interact with client computers 720a, 720b, 720c, 720d, 720e, etc. and other like devices, and databases 730.

### Exemplary Computing Device

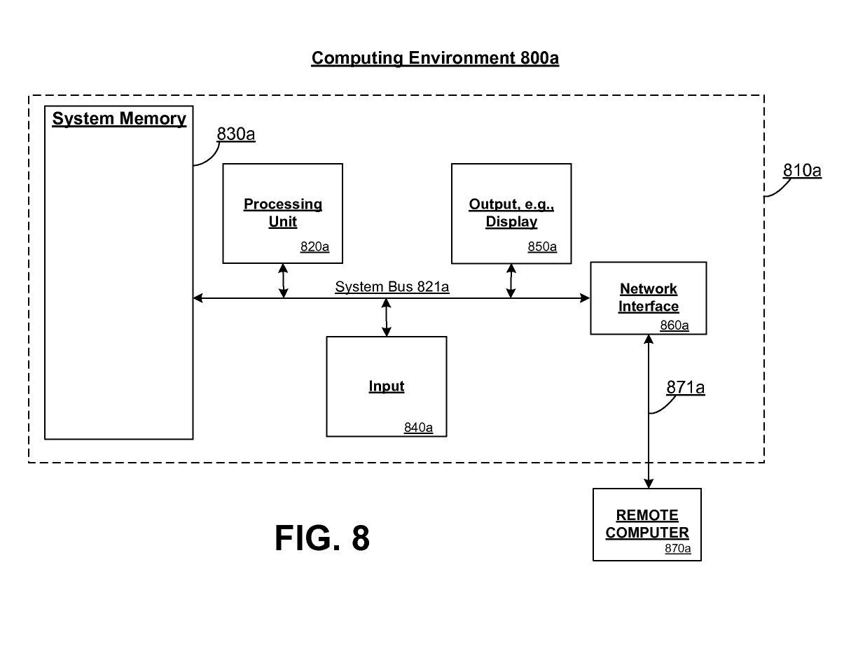

As mentioned, the invention applies to any device wherein it may be desirable to synchronize any kind of data across a set of devices. It should be understood, therefore, that handheld, portable and other computing devices and computing objects of all kinds are contemplated for use in connection with the present invention, i.e., anywhere that a device may benefit from sharing of data across devices or otherwise receive, process or store data. Accordingly, the below general purpose remote computer described below in FIG. 8 is but one example, and the present invention may be implemented with any client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance.

Although not required, the invention can partly be implemented via an operating system, for use by a developer of services for a device or object, and/or included within application software that operates in connection with the component(s) of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 8 thus illustrates an example of a suitable computing system environment 800a in which the invention may be implemented, although as made clear above, the computing system environment 800a is only one example of a suitable computing environment for a media device and is not intended to suggest any limitation as to the scope of use or functionality of the invention. Neither should the computing environment 800a be interpreted as having any dependency or requirement relating to any one or combination of components illustrated in the exemplary operating environment 800a.

With reference to FIG. 8, an exemplary remote device for implementing the invention includes a general purpose computing device in the form of a computer 810a. Components of computer 810a may include, but are not limited to, a processing unit 820a, a system memory 830a, and a system bus 821a that couples various system components including the system memory to the processing unit 820a. The system bus 821 a may be any of several types of bus structures including a memory bus or memory controller, a peripheral bus, and a local bus using any of a variety of bus architectures.

Computer 810a typically includes a variety of computer readable media. Computer readable media can be any available media that can be accessed by computer 810a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 810a. Communication media typically embodies computer readable instructions, data structures, program modules or other data in a modulated data signal such as a carrier wave or other transport mechanism and includes any information delivery media.

The system memory 830a may include computer storage media in the form of volatile and/or nonvolatile memory such as read only memory (ROM) and/or random access memory (RAM). A basic input/output system (BIOS), containing the basic routines that help to transfer information between elements within computer 810a, such as during start-up, may be stored in memory 830a. Memory 830a typically also contains data and/or program modules that are immediately accessible to and/or presently being operated on by processing unit 820a. By way of example, and not limitation, memory 830a may also include an operating system, application programs, other program modules, and program data.

The computer 810a may also include other removable/non-removable, volatile/nonvolatile computer storage media. For example, computer 810a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 821 a through a non-removable memory interface such as an interface, and a magnetic disk drive or optical disk drive is typically connected to the system bus 821 a by a removable memory interface, such as an interface.

A user may enter commands and information into the computer 810a through input devices such as a keyboard and pointing device, commonly referred to as a mouse, trackball or touch pad. Other input devices may include a microphone, joystick, game pad, satellite dish, scanner, or the like. These and other input devices are often connected to the processing unit 820a through user input 840a and associated interface(s) that are coupled to the system bus 821a, but may be connected by other interface and bus structures, such as a parallel port, game port or a universal serial bus (USB). A graphics subsystem may also be connected to the system bus 821a. A monitor or other type of display device is also connected to the system bus 821a via an interface, such as output interface 850a, which may in turn communicate with video memory. In addition to a monitor, computers may also include other peripheral output devices such as speakers and a printer, which may be connected through output interface 850a.

The computer 810a may operate in a networked or distributed environment using logical connections to one or more other remote computers, such as remote computer 870a, which may in turn have media capabilities different from device 810a. The remote computer 870a may be a personal computer, a server, a router, a network PC, a peer device or other common network node, or any other remote media consumption or transmission device, and may include any or all of the elements described above relative to the computer 810a. The logical connections depicted in FIG. 8 include a network 871a, such local area network (LAN) or a wide area network (WAN), but may also include other networks/buses. Such networking environments are commonplace in homes, offices, enterprise-wide computer networks, intranets and the Internet.

When used in a LAN networking environment, the computer 810a is connected to the LAN 871a through a network interface or adapter. When used in a WAN networking environment, the computer 810a typically includes a communications component, such as a modem, or other means for establishing communications over the WAN, such as the Internet. A communications component, such as a modem, which may be internal or external, may be connected to the system bus 821a via the user input interface of input 840a, or other appropriate mechanism. In a networked environment, program modules depicted relative to the computer 810a, or portions thereof, may be stored in a remote memory storage device. It will be appreciated that the network connections shown and described are exemplary and other means of establishing a communications link between the computers may be used.

There are multiple ways of implementing the present invention, e.g., an appropriate API, tool kit, driver code, operating system, control, standalone or downloadable software object, etc. which enables applications and services to use the systems and methods for representing and exchanging knowledge in accordance with the invention. The invention contemplates the use of the invention from the standpoint of an API (or other software object), as well as from a software or hardware object that performs the knowledge exchange in accordance with the invention. Thus, various implementations of the invention described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the present invention have been described in connection with various computing devices and network architectures, the underlying concepts may be applied to any computing device or system in which it is desirable to synchronize data with another computing device or system. For instance, the synchronization processes of the invention may be applied to the operating system of a computing device, provided as a separate object on the device, as part of another object, as a reusable control, as a downloadable object from a server, as a “middle man” between a device or object and the network, as a distributed object, as hardware, in memory, a combination of any of the foregoing, etc.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the synchronization services and/or processes of the present invention, e.g., through the use of a data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the flowcharts of FIG. 6. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the present invention in the context of particular programming language constructs, the invention is not so limited, but rather may be implemented in any language to provide methods for representing and exchanging knowledge for a set of nodes in accordance with the invention. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims

What is claimed is:

1. A method for synchronizing one or more data sources connectable via one or more networks, comprising:
receiving data from the one or more data sources;
identifying synchronization metadata for the data from the one or more data sources;
depending on the type of data received from the one or more data sources, performing knowledge based synchronization for the received data, the knowledge based synchronization utilizing data representative of any comprising the connection state of the one or more data sources to one or more other data sources, and changes to the data of the one or more data sources; and
generating a new data source comprising data representative of synchronized data from the one or more data sources.

2. The method of claim 1, further comprising detecting changes from the received data using a participating user input.

3. The method of claim 1, further comprising detecting changes in the received data by executing one or more selected machine reading techniques.

4. The method of claim 1, further comprising storing the changes in temporary data storage.

5. The method of claim 4, further comprising performing a synchronization between the received data and the changes detected changes.

6. The method of claim 1, further comprising applying one or more filtering techniques as part of knowledge based synchronization processing to the received data.

7. The method of claim 1, further comprising receiving first data from a first data source and second data from a second data source.

8. The method of claim 7, further comprising identifying synchronization meta-data for the first data and second data.

9. The method of claim 8, further comprising resolving conflicts between the received first data and received second data according to one or more selected techniques comprising input from a participating user and through automated data comparison processing.

10. A computer readable medium comprising computer executable instructions to instruct a computing environment to perform a method comprising:
receiving data from the one or more data sources;
identifying synchronization metadata for the data from the one or more data sources;
depending on the type of data received from the one or more data sources, performing knowledge based synchronization for the received data; and
generating a new data source comprising data representative of synchronized data from the one or more data sources.

11. A system to synchronize offline data comprising:
a synchronization engine operable to receive data from one or more data sources; and
an instruction set comprising at least one instruction to instruct the synchronization engine to process off-line data for synchronization according to a selected synchronization paradigm,
wherein the selected synchronization paradigm comprises one or more operations comprising identifying synchronization meta data for the received data from the one or more data sources for use in synchronizing the received data according to knowledge based synchronization to generate a new data source comprising synchronized data.

12. The system as recited in claim 11, further comprising a data store operative to store data representative of one or more operations of a synchronization process executed according to the selected synchronization paradigm.

13. The system as recited in claim 11, wherein the synchronization engine comprises a computing application.

14. The system as recited in claim 11, wherein the selected synchronization paradigm comprises one or more operations comprising synchronizing the received data from the one or more data sources according to a non-knowledge based synchronization technique.

15. The system as recited in claim 12, wherein the data store is operative to store data as part of a synchronization process of data from a first form with data from a second form.

16. The system as recited in claim 11, wherein the synchronization engine is operative to detect changes in the received data and storing the changes in a cooperating temporary data store.

17. The system as recited in claim 16, wherein the synchronization engine is operative to identify synchronization meta-data from the received data and/or from a cooperating meta-data data store.

18. The system as recited in claim 17, wherein the synchronization engine is operative to perform the synchronization between the received data and the cooperating temporary data store.

19. The system as recited in claim 18, wherein the synchronization engine is operative to generate a new data source comprising data representative of the synchronized data.

20. The system as recited in claim 18, wherein the synchronization engine is operative to update the tick-count on the received data from the one or more data sources.
